(19) United States
(12) Patent Application Publication
(10) Pub. No.: US 2024/0054083 A1
(43) Pub. Date: Feb. 15, 2024

(54) SEMICONDUCTOR DEVICE

(71) Applicant: RENESAS ELECTRONICS CORPORATION, Tokyo (JP)

(72) Inventors: Kazuaki TERASHIMA, Tokyo (JP); Isao NAGAYOSHI, Tokyo (JP); Atsushi NAKAMURA, Tokyo (JP)

(21) Appl. No.: 18/336,215

(22) Filed: Jun. 16, 2023

(30) Foreign Application Priority Data
Aug. 8, 2022 (JP) 2022-126565

(51) Int. Cl. G06F 13/16; G06F 13/28; G06F 7/544

(52) U.S. Cl. CPC G06F 13/1673; G06F 13/28; G06F 7/5443

(57) ABSTRACT

A semiconductor device capable of shortening processing time of a neural network is provided. The memory stores a compressed weight parameter. A plurality of multiply accumulators perform a multiply-accumulation operation to a plurality of pixel data and a plurality of weight parameters. A decompressor restores the compressed weight parameter stored in the memory to a plurality of weight parameters. A memory for weight parameter stores the plurality of weight parameters restored by the decompressor. The DMA controller transfers the plurality of weight parameters from the memory to the memory for weight parameter via the decompressor. A sequence controller writes down the plurality of weight parameters stored in the memory for weight parameter to a weight parameter buffer at write timing.

### CROSS-REFERENCE TO RELATED APPLICATION

The disclosure of Japanese Patent Application No. 2022-126565 filed on Aug. 8, 2022, including the specification, drawings and abstract is incorporated herein by reference in its entirety.

### BACKGROUND

The present invention relates to a semiconductor device, and relates to, for example, a semiconductor device that executes a neural network processing.

There is disclosed technique listed below.
[Patent Document 1] Japanese Unexamined Patent Application Publication No. 2019-40403

The Patent Document 1 discloses a semiconductor device in which one integrated coefficient table is generated by integrating input coefficient tables of a plurality of channels, each coefficient included in the integrated coefficient table is multiplied by each pixel value of an input image, and each multiplication result is cumulatively added for each channel number. In addition, the integrated coefficient table is exemplified as a table obtained by extracting the largest coefficient from the coefficients at the same matrix location in the plurality of channels, or a table obtained by expanding a matrix size so as to include each coefficient for a plurality of channels.

### SUMMARY

For example, in a neural network processing such as Convolutional Neural Network (CNN), huge calculation processing is executed using a plurality of multiply accumulators (referred to as Multiply ACcumulate (MAC) circuits) mounted on the semiconductor device. Specifically, the MAC circuit mainly executes the multiply-accumulate operation to a plurality of pixel data contained in the image data and a plurality of weight parameters contained in a filter.

The pixel data and the weight parameters are stored in, for example, a memory, and is transferred to the MAC circuit via a DMA (Direct Memory Access) controller. At this time, in order to reduce a required memory capacity, the weight parameters may occasionally be stored in the memory in a compressed state and be transferred to the MAC circuit via a decompressor. However, when the number of filter channels, eventually an amount of weight parameter data is large or when a weight parameter compression ratio is low, it takes time to transfer the weight parameters from the memory to the MAC circuit. As a result, there is a risk of increase in time for the neural network processing due to limitation of the transfer time of the weight parameters.

Embodiments described later have been made in consideration of such circumstances, and other issues and novel characteristics will be apparent from the description of the present specification and the accompanying drawings.

A semiconductor device according to one embodiment executes neural network processing, and includes a first memory, a second memory, a plurality of multiply accumulators, a weight parameter buffer, a data input buffer, a decompressor, a third memory, a first DMA controller, a second DMA controller, and a sequence controller. The first memory stores the compressed weight parameters. The second memory stores a plurality of pixel data. The plurality of multiply accumulators perform a multiply-accumulation operation on a plurality of pixel data and a plurality of weight parameters. The weight parameter buffer outputs the plurality of weight parameters to the plurality of multiply accumulators. The data input buffer outputs the plurality of pixel data to the plurality of multiply accumulators. The decompressor restores the compressed weight parameters stored in the first memory into the plurality of weight parameters. The third memory is provided between the decompressor and the weight parameter buffer and stores the plurality of weight parameters restored by the decompressor. The first DMA controller reads out the compressed weight parameters from the first memory and transfers the weight parameters to the third memory via the decompressor. The second DMA controller transfers the plurality of pixel data from the second memory to the data input buffer. The sequence controller writes the plurality of weight parameters stored in the third memory to the weight parameter buffer at write timing.

By using the semiconductor device of one embodiment, the time for the neural network processing can be shortened.

### BRIEF DESCRIPTION OF THE DRAWINGS

FIG. 1 is a schematic diagram showing a configuration example of a principal part in a semiconductor device according to a first embodiment.

FIG. 2 is a schematic diagram showing a configuration example of a neural network processed by a neural network engine shown in FIG. 1.

FIG. 3A is a schematic diagram showing a schematic operation example of a principal part of a MAC unit in FIG. 1.

FIG. 3B is a schematic diagram showing an operation example continued from FIG. 3A.

FIG. 4 is a diagram showing a detailed configuration example of the principal part of the neural network engine in FIG. 1.

FIG. 5 is a diagram for explaining an example of a processing content of a decompressor in FIG. 4.

FIG. 6 is a diagram showing a specific example of the processing content in FIG. 5.

FIG. 7A is a timing chart showing a schematic operation example of the neural network engine in FIG. 4.

FIG. 7B is a supplementary diagram for explaining an operation example of FIG. 7A.

FIG. 8A is a timing chart showing an operation example different from that FIG. 7A.

FIG. 8B is a supplementary diagram for explaining an operation example of FIG. 8A.

FIG. 9 is a diagram showing a detailed configuration example of the principal part of the neural network engine in FIG. 1 in a semiconductor device according to a second embodiment.

FIG. 10 is a diagram showing a detailed configuration example of the principal part of the neural network engine in FIG. 1 in a semiconductor device according to a third embodiment.

FIG. 11 is a timing chart showing a schematic operation example of a neural network engine according to a comparative example.

### DETAILED DESCRIPTION

In the embodiments described below, the invention will be described in a plurality of sections or embodiments when required as a matter of convenience. However, these sections or embodiments are not irrelevant to each other unless otherwise stated, and the one relates to the entire or a part of the other as a modification example, details, or a supplementary explanation thereof. Also, in the embodiments described below, when referring to the number of elements (including number of pieces, values, amount, range, and the like), the number of the elements is not limited to a specific number unless otherwise stated or except the case where the number is apparently limited to a specific number in principle. The number larger or smaller than the specified number is also applicable. Further, in the embodiments described below, it goes without saying that the components (including element steps) are not always indispensable unless otherwise stated or except the case where the components are apparently indispensable in principle. Similarly, in the embodiments described below, when the shape of the components, positional relation thereof, and the like are mentioned, the substantially approximate and similar shapes and the like are included therein unless otherwise stated or except the case where it is conceivable that they are apparently excluded in principle. The same goes for the numerical value and the range described above.

Hereinafter, embodiments will be described in detail with reference to the accompanying drawings. Note that components having the same function are denoted by the same reference signs throughout the drawings for explaining the embodiments, and the repetitive description thereof will be omitted. In addition, the description of the same or similar portions is not repeated in principle unless otherwise particularly required in the following embodiments.

### First Embodiment

<Outline of Semiconductor Device>

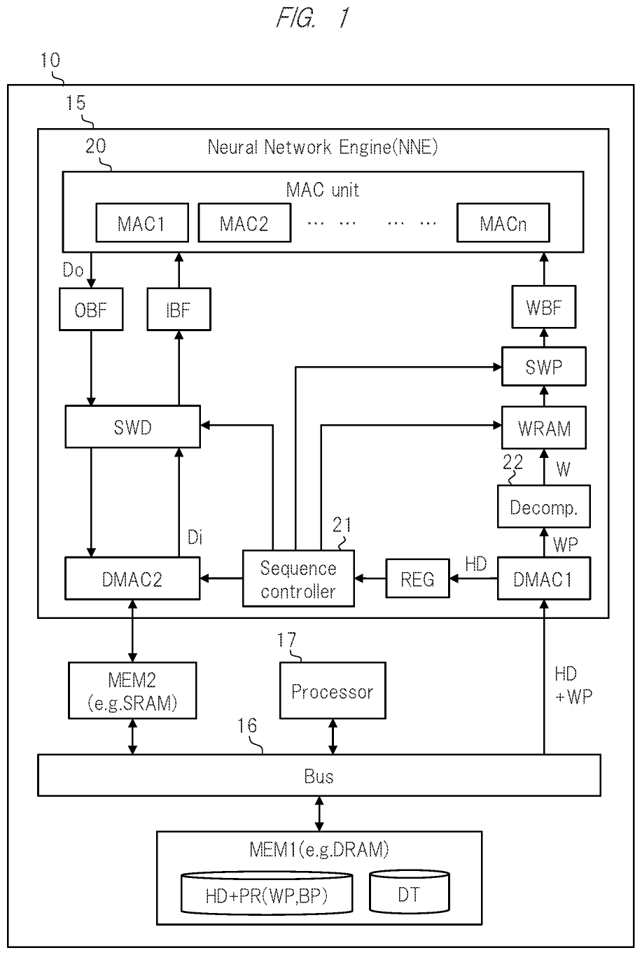

FIG. 1 is a general diagram showing a configurational example of a principal part of a semiconductor device of a first embodiment. A semiconductor device 10 shown in FIG. 1 is, for example, a System on Chip (SoC) made of one semiconductor chip or others. This semiconductor device 10 is typically mounted on an Electronic Control Unit (ECU) of a vehicle or others, and provides a function of Advanced Driver Assistance System (ADAS).

The semiconductor device 10 shown in FIG. 1 includes: a neural network engine (NNE) 15; a processor 17 such as a Central Processing Unit (CPU); memories MEM1 and MEM2; and a system bus 16. The system bus 16 connects the neural network engine 15, the memories MEM1 and MEM2 and the processor 17. The neural network engine 15 executes a neural network processing typified by the CNN. The processor 17 executes a predetermined program stored in the memory MEM1 to cause the semiconductor device 10 to play a role of a predetermined function including control for the neural network engine 15.

The memory (first memory) MEM1 is, for example, a Dynamic Random Access Memory (DRAM). The memory MEM1 stores image data DT made of a plurality of pixel data, a parameter PR, and a header HD added to the parameter PR. The parameter PR includes a weight parameter WP and a bias parameter BP. The header HD includes various types of information for controlling a sequence operation of the neural network engine 15 so as to include setting information of a switch circuit SWP for parameter described later.

The neural network engine 15 includes: a plurality of DMA controllers DAMC1 and DMAC2; a MAC unit 20; a sequence controller 21; a decompressor 22; a memory WRAM for weight parameter; a register REG; a switch circuit SWD for data; a switch circuit SWP for parameter; and various buffers. The various buffers include: a weight parameter buffer WBF; a data input buffer IBF; and a data output buffer OBF. The various buffers may be, in detail, registers composed of latch circuits such as flip-flops.

The MAC unit 20 includes “n” MAC circuits MAC1 to MACn, where “n” is an integer of 2 or more. Each of the n MAC circuits MAC1 to MACn has, for example, a plurality of multipliers and one adder that adds multiplication results from the plurality of multipliers, and thus, performs a multiply-accumulate operation. In the specification, the n MAC circuits MAC1 to MACn are collectively referred to as MAC circuits MAC. The weight parameter buffer WBF outputs, for example, the stored weight parameter W to the n MAC circuits MAC1 to MACn in the MAC unit 20.

The DMA controller (first DMA controller) DMAC1 transfers a plurality of weight parameters W from the memory MEM1 to the memory WRAM for weight parameter via the system bus 16. More specifically, the memory MEM1 stores, for example, compressed weight parameters WP. The DMA controller DMAC1 reads out the header HD and the compressed weight parameters WP from the memory MEM1. The DMA controller DMAC1 then transfers the header HD to the register REG and transfers the compressed weight parameter WP to the memory WRAM for weight parameter via the decompressor 22. At this time, the decompressor 22 restores the compressed weight parameters WP to a plurality of weight parameters W.

The memory (third memory) WRAM for weight parameter is, for example, an SRAM (Static Random Access Memory), and more specifically, includes a plurality of SRAMs. The memory WRAM for weight parameter stores a plurality of weight parameters W restored by the decompressor 22. The switch circuit SWP for parameter includes, for example, a crossbar switch or others. The switch circuit SWP for parameter outputs the plurality of weight parameters W read out from the memory WRAM for weight parameter to each storage region included in the weight parameter buffer WBF by performing 1-to-1 connection, 1-to-N connection, N-to-1 connection or others based on the setting. Note that the header HD includes, for example, setting information of this switch circuit SWP or others.

The memory MEM2 is, for example, a Static Random Access Memory (SRAM) or others, and is used as a high-speed cache memory of the neural network engine 15. For example, the image data DT, that is the pixel data, in the memory MEM1 is previously copied in the memory MEM2, and then, is used in the neural network engine 15. The data input buffer IBF outputs the plurality of stored pixel data Di to the n MAC circuits MAC1 to MACn in the MAC unit 20. The DMA controller (second DMA controller) DMAC2 transfers the plurality of pixel data Di from the memory MEM2 to the data input buffer IBF.

In this manner, each MAC circuit MAC of the MAC unit 20 performs the multiply-accumulate operation to the plurality of weight parameters W output from the weight parameter buffer WBF and the plurality of pixel data Di output from the data input buffer IBF, in other words, performs a convolution layer processing. Although details are omitted, the MAC unit 20 may perform various necessary processing for the CNN, such as addition of a value of the bias parameter BP to the multiply-accumulate operation result, calculation of an activating function and a pooling layer processing. The MAC unit 20 writes down the pixel data Do resulted from such CNN processing into the data output buffer OBF.

The DMA controller DMAC2 transfers the pixel data Do from the data output buffer OBF to the memory MEM2. The pixel data Do transferred to the memory MEM2 is used as pixel data Di to be input to a next convolution layer, in other words, input pixel data Di. More specifically, the pixel data is specifically transferred between the DMA controller DMAC2 and the data input buffer IBF or the data output buffer OBF via the switch circuit SWD for data. The switch circuit SWD includes, for example, a crossbar switch or others, and performs 1-to-1 connection, 1-to-N connection, N-to-1 connection or others based on the setting.

The sequence controller 21 controls the overall operation sequence of the neural network engine (NNE) 15. As one example, the sequence controller 21 sets the connection of the switch circuit SWP for parameter, based on the information of the header HD stored in the register REG. And, the sequence controller 21 sets, for example, the transfer of the DMA controller DMAC2 and the connection of the switch circuit SWD for data, based on not-illustrated setting information output from the processor 17, not-illustrated command data stored in the memory MEM1 or others.

In the setting for the transfer of the DMA controller DMAC2, an address range at the time of the transfer of the pixel data Di from the memory MEM2, an address range at the time of the transfer of the pixel data Do to the memory MEM2 and others are determined. In the setting for the connection of the switch circuit SWD for data, a detailed correspondence between a reading address of the memory MEM2 and each storage region included in the data input buffer IBF, a detailed correspondence between a writing address of the memory MEM2 and each storage region included in the data output buffer OBF and others are determined.

Furthermore, the sequence controller 21 controls an access to the memory WRAM for weight parameter. Incidentally, although the sequence controller 21 is provided here, the processor 17 may control the overall operation sequence of the neural network engine (NNE) 15 instead of the sequence controller 21.

<Outline of Neural Network>

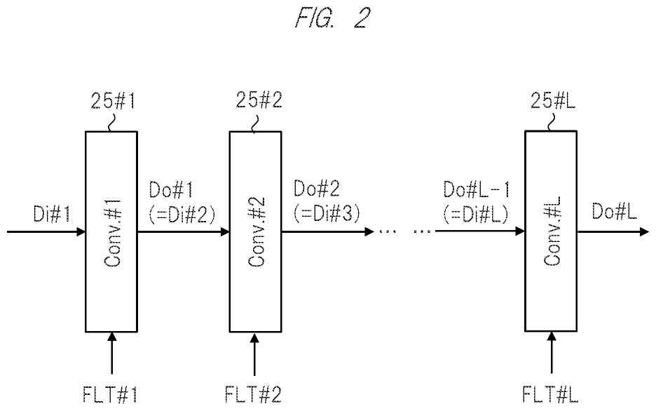

FIG. 2 is a schematic diagram showing a configuration example of a neural network processed by the neural network engine shown in FIG. 1. The neural network shown in FIG. 2 includes “L” convolution layers 25 #1, 25 #2, . . . 25 #L where L is an integer of 2 or more. In the convolution layer 25 #1, a convolution operation for first-layer input pixel data Di #1 stored in the memory MEM2 and a weight parameter W in a first-layer filter FLT #1 stored in the memory MEM1 and restored by the decompressor 22 is performed. Then, in the convolution layer 25 #1, a result of the convolution operation is written down as first-layer output pixel data Do #1 to the memory MEM2.

In the convolution layer 25 #2, a convolution operation for the first-layer output pixel data Do #1 stored in the memory MEM2 used as second-layer input pixel data Di #2 and a weight parameter W in a second-layer filter FLT #2 stored in the memory MEM1 and restored by the decompressor 22 is performed. Then, in the convolution layer 25 #2, a result of the convolution operation is written down as second-layer output pixel data Do #2 to the memory MEM2.

Similarly, subsequently, in the convolution layer 25 #L, a convolution operation for the (L−1 th)-layer output pixel data Do #L−1 stored in the memory MEM2 used as L-th-layer input pixel data Di #L and a weight parameter W in a L-th-layer filter FLT #L stored in the memory MEM1 and restored by the decompressor 22 is performed. Then, in the convolution layer 25 #L, a result of the convolution operation is written down as L-th-layer output pixel data Do #L to the memory MEM2 or MEM1.

Incidentally, more specifically, for example, in the convolution layer 25 #1, output pixel data Do #1 is generated by addition of a value of the bias parameter BP stored in the memory MEM1 to the result of the convolution operation, or by an activation function operation. The addition of the value of the bias parameter BP or the activation function operation is similarly performed also in the other convolutional layers 25 #2, . . . , 25 #L. Further, pooling layers may also be provided between the consecutive convolutional layers as appropriate. In the specification, the addition of the value of the bias parameter BP, the activation function operation, and the processing of the pooling layer will be omitted for simplicity of explanation. Also, in the specification, each filter is generically referred to as a filter FLT.

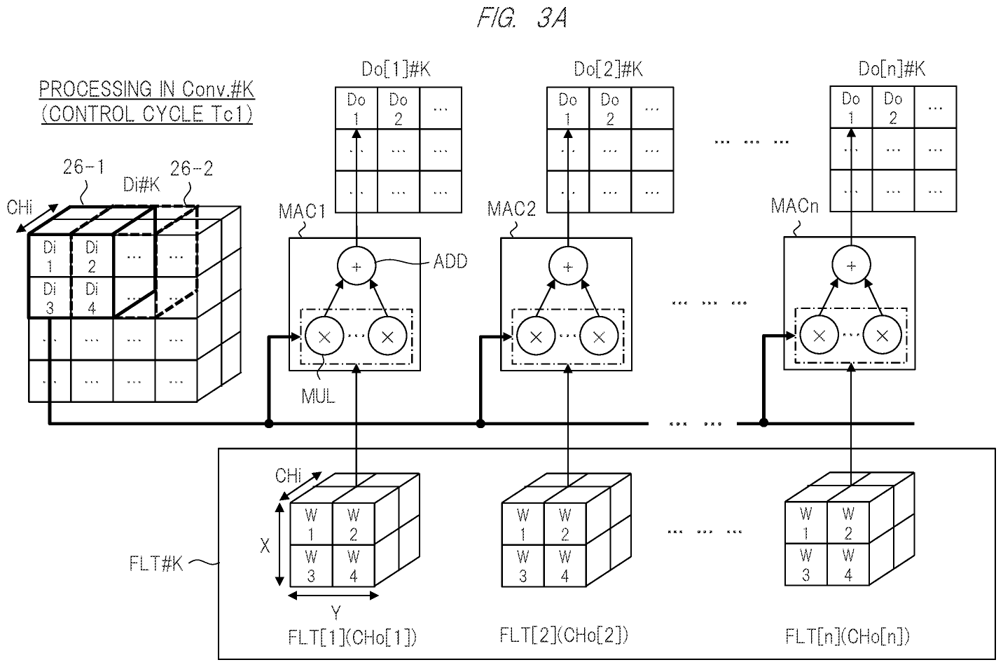

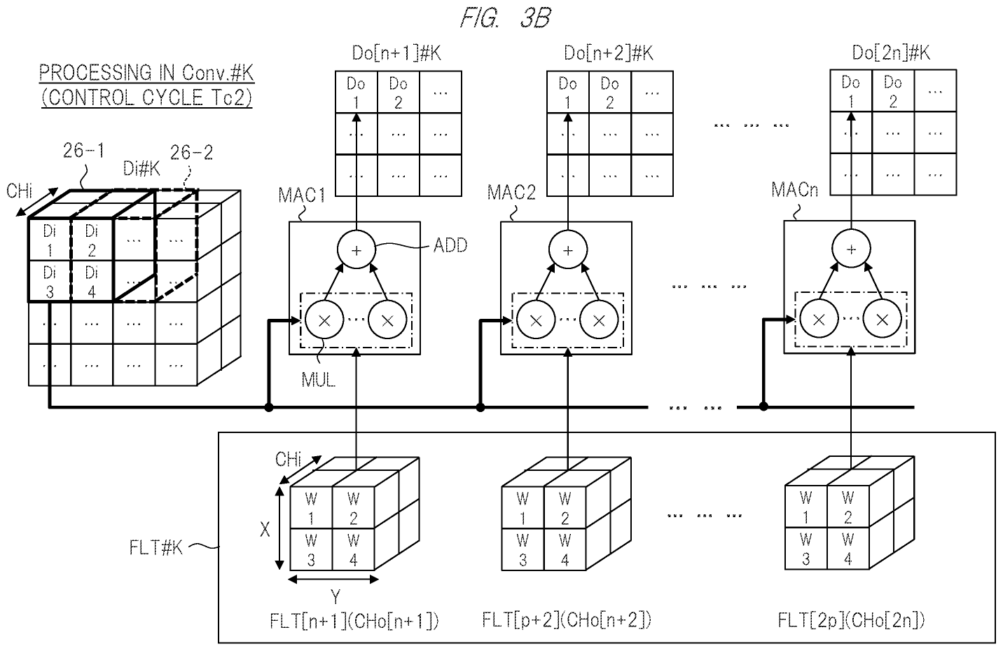

FIG. 3A is a schematic diagram showing a general operation example of a principal part of the MAC unit in FIG. 1. FIG. 3B is a schematic diagram showing an operation example continued from FIG. 3A. FIGS. 3A and 3B show a part of contents of processings performed in one convolutional layer 25 #K shown in FIG. 2, where K is any one integer of 1 to L. FIG. 3A shows processing contents with a certain control cycle Tc1, and FIG. 3B shows processing contents with a control cycle Tc2 subsequent thereto.

In FIG. 3A, the filter FLT #K input to the convolutional layer 25 #K is composed of filters of a plurality of output channels CHo. In an example of FIG. 3A, the filter FLT #K includes filters FLT[1], FLT[2], . . . , FLT[n] of “n” output channels CHo[1], CHo[2], . . . , CHo[n] that are some of a plurality of output channels CHo.

Each of the filters FLT[1], FLT[2], . . . , FLT[n] has a filter size of “X×Y×Chi” where “Chi” is used as an input channel, and, in the example, has a filter size of “2×2×Chi”. That is, each of the filters FLT[1], FLT[2], . . . , FLT[n] is composed of “2×2×Chi” weight parameters W including four weight parameters W1, W2, W3, W4. However, the values of the four weight parameters W1, W2, W3, W4 may differ for each of the filter FLT [1], FLT [2], . . . , FLT [n].

Meanwhile, the input pixel data Di #K input to the convolutional layer 25 #K is composed of pixel data of a plurality of input channels CHi. In the input pixel data Di #K, a first pixel space 26-1 associated with the convolution processing is composed of “2×2×Chi” pieces of pixel data including the pixel data Di1, Di2, Di3, Di4, based on the filter size described above.

The MAC circuit MAC1 performs the multiply-accumulate operation to the respective pieces of pixel data Di1, Di2, Di3, Di4, . . . included in the first pixel space 26-1 associated with the convolution operation and the respective weight parameters W1, W2, W3, W4, contained in the filter FLT[1] of the output channel Cho [1]. Consequently, the MAC circuit MAC1 generates the pixel data Do1 of the first pixel in the output pixel data Do[1]#K of the output channel CHo[1].

In parallel to the MAC circuit MAC1, the MAC circuit MAC2 performs the multiply-accumulate operation to the respective pieces of pixel data Di1, Di2, Di3, Di4, . . . included in the first pixel space 26-1 and the respective weight parameters W1, W2, W3, W4, . . . contained in the filter FLT[2] of the output channel Cho[2]. Consequently, the MAC circuit MAC2 generates the pixel data Do1 of the first pixel in the output pixel data Do[2]#K of the output channel CHo[2].

Similarly, in parallel to the MAC circuit MAC1, the MAC circuit MACn performs the multiply-accumulate operation to the respective pieces of pixel data Di1, Di2, Di3, Di4, . . . included in the first pixel space 26-1 and the respective weight parameters W1, W2, W3, W4, . . . contained in the filter FLT[n] of the output channel Cho[n]. Consequently, the MAC circuit MACn generates the pixel data Do1 of the first pixel in the output pixel data Do [n] #K of the output channel CHo[n] Incidentally, each of the n MAC circuits MAC1 to MACn includes, for example, “X×Y×Chi” multipliers MUL and one adder ADD for adding multiplication results of these multipliers MUL.

After completing the operation in the control cycle Tc1 as shown in FIG. 3A, an operation in the control cycle Tc2 as shown in FIG. 3B is performed. FIG. 3B is different from FIG. 3A in the used filters. That is, the filter FLT #K input to the convolutional layer 25 #K further includes filters FLT[n+1], FLT[n+2], . . . , FLT[2n] of “n” output channels Cho[n+1], Cho[n+1], . . . , Cho[2n], which are the others of the plurality of output channels Cho, in addition to the filters shown in FIG. 3.

The MAC circuit MAC1 performs the multiply-accumulate operation to the respective pieces of pixel data Di1, Di2, Di3, Di4, . . . included in the first pixel space 26-1 and the respective weight parameters W1, W2, W3, W4, . . . contained in the filter FLT[n+1] of the output channel Cho[n+1]. Consequently, the MAC circuit MAC1 generates the pixel data Do1 of the first pixel in the output pixel data Do[n+1]#K of the output channel CHo[n+1].

Similarly, in parallel to the MAC circuit MAC1, the MAC circuit MACn performs the multiply-accumulate operation to the respective pieces of pixel data Di1, Di2, Di3, Di4, . . . included in the first pixel space 26-1 and the respective weight parameters W1, W2, W3, W4, . . . contained in the filter FLT[2n] of the output channel Cho[2n]. Consequently, the MAC circuit MACn generates the pixel data Do1 of the first pixel in the output pixel data Do[2n]#K of the output channel CHo[2n].

Similarly, subsequently, the multiply-accumulate operation is performed to the first pixel space 26-1 as a target while the filters are changed until it reaches the last output channel CHo. Then, after completing the multiply-accumulate operation to the first pixel space 26-1 targeted, the same processing as for the first pixel space 26-1 is performed to, as a target, a second pixel space 26-2 associated with a convolution processing, as shown in FIGS. 3A and 3B. Consequently, the pixel data Do2 of the second pixel in the output pixel data Do [1] #K, . . . , Do [2n] #K, is generated, and the pixel data of all the pixels is further similarly generated. The output pixel data Do of the plurality of output channels CHo thus generated is used as input pixel data Di of a plurality of input channels CHi in a next convolution layer 25 #K+1.

Here, as a processing procedure of the neural network, in addition to a procedure A that is parallel processing performed in an output channel CHo direction first as shown in FIGS. 3A and 3B, a procedure B that is parallel processing performed in a shift direction of a pixel space first, and a procedure C that is combination of the procedures A and B to be parallel processing performed in the output channel CHo direction and the shift direction in the pixel space are exemplified. In the procedure B, in FIG. 3A, the weight parameter W of the filter FLT[1] is commonly input to the n MAC circuits MAC1 to MACn. Meanwhile, the image data Di in the first pixel space 26-1, second pixel space 26-2, . . . , n-th pixel space are input to the n MAC circuits MAC1, MAC2, . . . , MACn, respectively.

In especially the procedure A of the procedure A or procedure C, the data amount of the weight parameter W input to the n MAC circuits MAC1 to MACn is larger than in the procedure B. This data amount of the weight parameter W is further increased as the number of input channels CHi and the number of output channels CHo increase. As shown in FIG. 1, the weight parameter W is transferred from the memory MEM1 such as a DRAM to the weight parameter buffer WBF via the system bus 16, the decompressor 22, and the like by using the DMA controller DMAC1. Meanwhile, the pixel data Di is transferred from the memory MEM2 such as an SRAM to the data input buffer IBF by using the DMA controller DMAC2.

Due to a difference between the memories MEM1 and MEM2 and a difference between data transfer paths, a data transfer speed of the weight parameter W can be slower than a data transfer speed of the pixel data Di. In a case of the procedure B, the data amount of weight parameter W is small, and therefore, this difference between the data transfer speeds does not pose a particular problem in many cases. However, in a case of the procedure A or procedure C, the data amount of weight parameter W is large, and therefore, the difference between the data transfer speeds may pose the problem. Specifically, a processing time of the neural network may increase due to limitation on the transfer time of the weight parameter W. Therefore, in the configuration example of FIG. 1, a memory WRAM for weight parameter is provided.

<Details of Neural Network Engine>

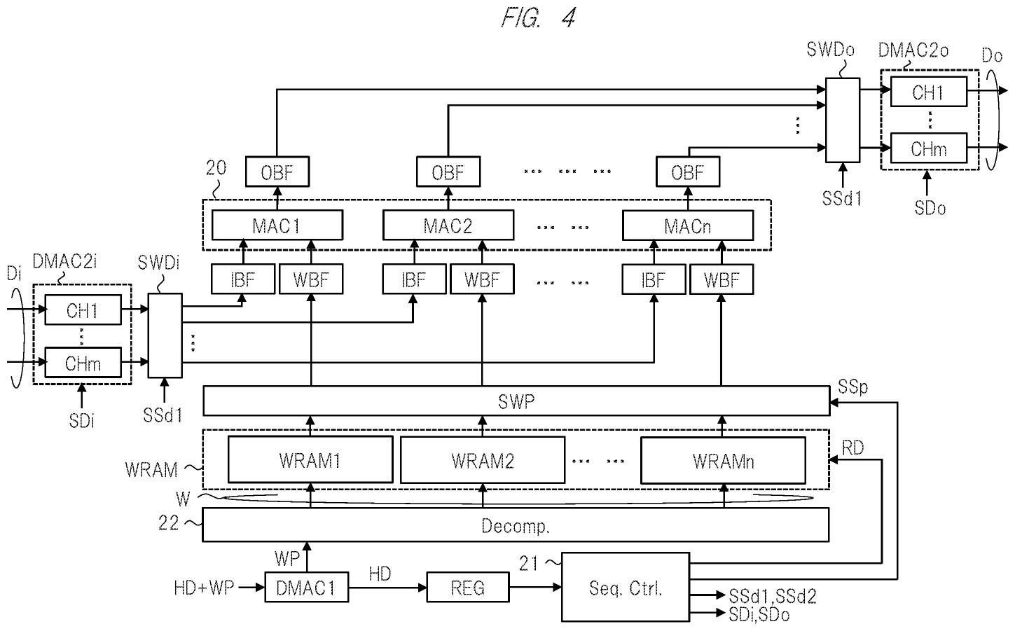

FIG. 4 is a diagram showing a detailed configuration example of a principal part of the neural network engine in FIG. 1. In FIG. 4, the MAC unit 20 includes n MAC circuits MAC1 to MACn. Each of the n MAC circuits MAC1 to MACn includes “X×Y×Chi” multipliers MUL and one adder ADD, as described in FIG. 3A. However, the number of multipliers MUL included in one MAC circuit MAC varies depending on a filter size of “X×Y×CHi”. Therefore, in the MAC unit 20, the number of multipliers MUL included in one MAC circuit MAC is variably set based on a unshown set signal.

A data input buffer IBF, a weight parameter buffer WBF, and a data output buffer OBF are provided for each of the n MAC circuits MAC1 to MACn. The n data input buffers IBF, weight parameter buffers WBF, and data output buffers OBF may be n data input registers, weight parameter registers, and data output registers, respectively. The DMA controller DMAC1 transfers the weight parameter W from the memory MEM1 shown in FIG. 1 via the decompressor 22 to the memory WRAM for weight parameter. At this time, the decompressor 22 restores the compressed weight parameters WP, which are stored in the memory MEM1 and read out by the DMA controller DMAC1, to a plurality of weight parameters W.

More specifically, for example, n weight parameter memories WRAM are provided. The weight parameters W read out from the n weight parameter memories WRAM1 to WRAMn are written down to the weight parameter buffers WBF of the n MAC circuits MAC1 to MACn via the switch circuits SWP for parameter. The switch circuit SWP determines to which of the n weight parameter memories WRAM1 to WRAM the plurality of weight parameters W read out from the memory WRAM for weight parameter are to be output, based on the set signal SSp output from the sequence controller 21.

Meanwhile, the DMA controller DMAC2 for pixel data shown in FIG. 1 particularly has a DMA controller DMAC2i for data input and a DMA controller DMAC2o for data output as shown in FIG. 4. Similarly, the switch circuit SWD for data shown in FIG. 1 also particularly has a switch circuit SWDi for data input and a switch circuit SWDo for data output as shown in FIG. 4.

The DMA controller DMAC2i for data input controls data transfer by using “m” transfer channels CH1 to CHm where m is an integer of 2 or more. The DMA controller DMAC2i transfers the pixel data Di from the memory MEM2 shown in FIG. 1 to the n data input buffers IBF via the switch circuit SWDi for data input, based on the set signal SDi from the sequence controller 21. At this time, the switch circuit SWDi determines to which of the n data input buffers IBF the pixel data Di output from the m transfer channels CH1 to CHm is to be output, based on the set signal SSd1 output from the sequence controller 21.

The DMA controller DMAC2o for data output also controls data transfer by using the m transfer channels CH1 to CHm. The DMA controller DMAC2o transfers the pixel data Do from the data output buffer OBF to the MEM2 shown in FIG. 1 via the switch circuit SWDo for data output, based on the set signal SDo output from the sequence controller 21. At this time, the switch circuit SWDo determines, for example, appropriate mapping of the pixel data Do to be written down into the memory MEM2, based on the set signal SSd1 output from the sequence controller 21.

The sequence controller 21 outputs the various set signals SDi, SDo, SSd1, SSd2, SSp and a read signal RD. The set signals SDi, SDo are generated based on, for example, unshown setting information output from the processor 17 and unshown command data stored in the memory MEM1, and are output to the DMA controllers DMAC2i, DMAC2o for data, respectively. The set signals SSd1, SSd2 are also generated in the same manner, and are output to the switch circuits SWDi, SWDo for data, respectively. The set signal SSp is generated based on, for example, the information of the header HD stored in the register REG, and is output to the switch circuit SWP for parameter.

Meanwhile, the read signal RD is output to the memory WRAM for weight parameter. The memory WRAM for weight parameter performs a read operation in accordance with the read signal RD. Consequently, the sequence controller 21 can write down the plurality of weight parameters W stored in the memory WRAM for weight parameter to the weight parameter buffer WBF at the write timing. The write timing is, for example, timing synchronized with timing at which the transfer of the pixel data Di to the data input buffer IBF is completed. Based on this, the output timing of the read signal RD is also determined.

[Details of Decompressor]

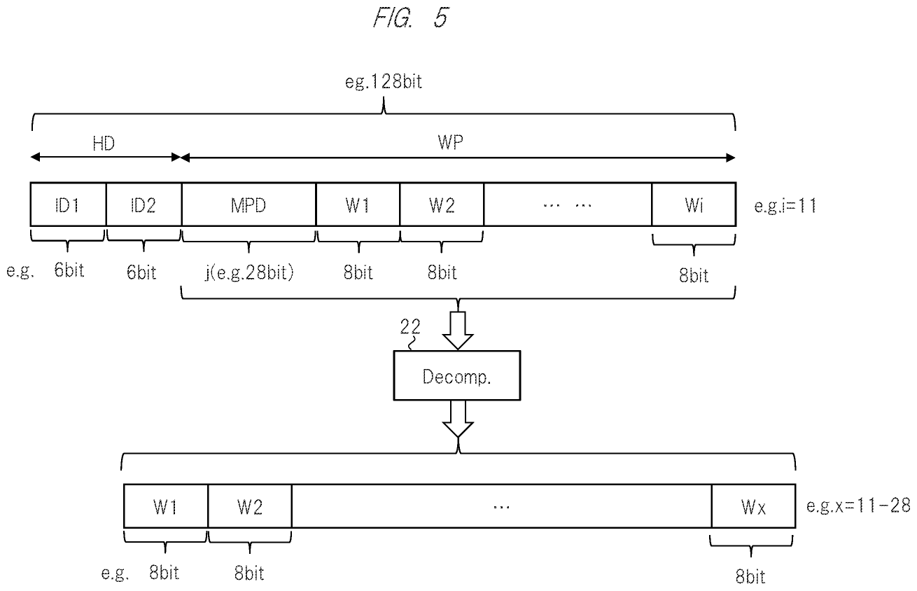

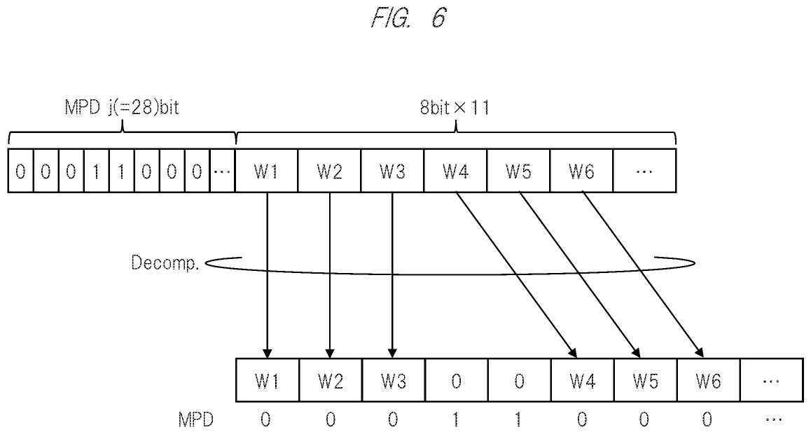

FIG. 5 is a diagram for explaining an example of processing contents of the decompressor in FIG. 4. FIG. 6 is a diagram showing a specific example of the processing contents in FIG. 5. First, as described with reference to FIG. 1, the memory MEM1 previously stores the compressed weight parameters WP as shown in FIG. 5. Then, as shown in FIG. 5, the DMA controller DMAC1 for parameter reads out the compressed weight parameter WP and the header HD attached thereto from the memory MEM1, and outputs the compressed weight parameter WP therein to the decompressor 22.

As shown in FIG. 4, the header HD is output to the sequence controller 21 via the register REG. As shown in FIG. 5, the header HD includes, for example, a transfer-source identifier ID1 and a transfer-destination identifier ID2 and others used in the switch circuit SWP for parameter. The sequence controller 21 determines relation of connection in the switch circuit SWP, based on the information of this header HD.

In FIG. 5, the compressed weight parameter WP is made of a set of map data MPD of “j” bits that are 28 bits in this example, where “j” is an integer number of 2 or more, and “i”, that is 11 in this example, weight parameters W1, W2 . . . , Wi where “i” is an integer number of 2 or more. Each bit of the map data MPD of 28 bits represents that the weight parameter is either zero or non-zero. The 11 weight parameters W1, W2 . . . , Wi are sequentially corresponded to the bits representing the non-zero in the map data MPD. As a result, the decompressor 22 restores at least 11 and at most 28 weight parameters W1, W2 . . . , Wx from the compressed weight parameters WP including the 11 weight parameters WP1, WP2 . . . , WPi.

As a specific example, in an example of FIG. 6, the map data MPD of 28 bits include “00011000 . . . ”, and the 11 weight parameters W sequentially include W1, W2, W3, W4, W5, W6 . . . . The 28 bits of the map data MPD correspond to the 28 weight parameters W, respectively, and each of the 28 weight parameters W represents either the zero or the non-zero. In this example, the weight parameter W corresponding to the bit representing that the map data MPD is “1” is zero. The 11 weight parameters W are sequentially corresponded as the weight parameters each corresponding to the bit representing that the map data MPD is “0”.

In this manner, as shown in FIG. 6, the decompressor 22 outputs the plurality of restored weight parameters W1, W2, W3, 0, 0, W4, W5, W6 . . . . Based on such a method, if all 28 bits of the map data MPD in FIG. 5 represent “1”, the decompressor 22 outputs the 28 zero weight parameters. On the other hand, if all the first to eleventh bits of the map data MPD represent “0”, the decompressor 22 outputs the 11 weight parameters W1, W2, . . . , W11 representing the non-zero.

The decompressor 22 outputs the 28 weight parameters W at the maximum in the example of FIG. 5. The maximum number of weight parameters W can be increased by expanding a bit width shown in FIG. 5 from 128 bits to 256 bits, 512 bits, or the like. Meanwhile, in an actual processing of the convolutional layer, too large number of weight parameters W to be handled by such a bit width expansion may be required in a given control cycle. In this case, the decompressor 22 executes repeatedly the restoration processing as described above until the required number of weight parameters W is obtained.

[Entire Operation of Neural Network Engine]

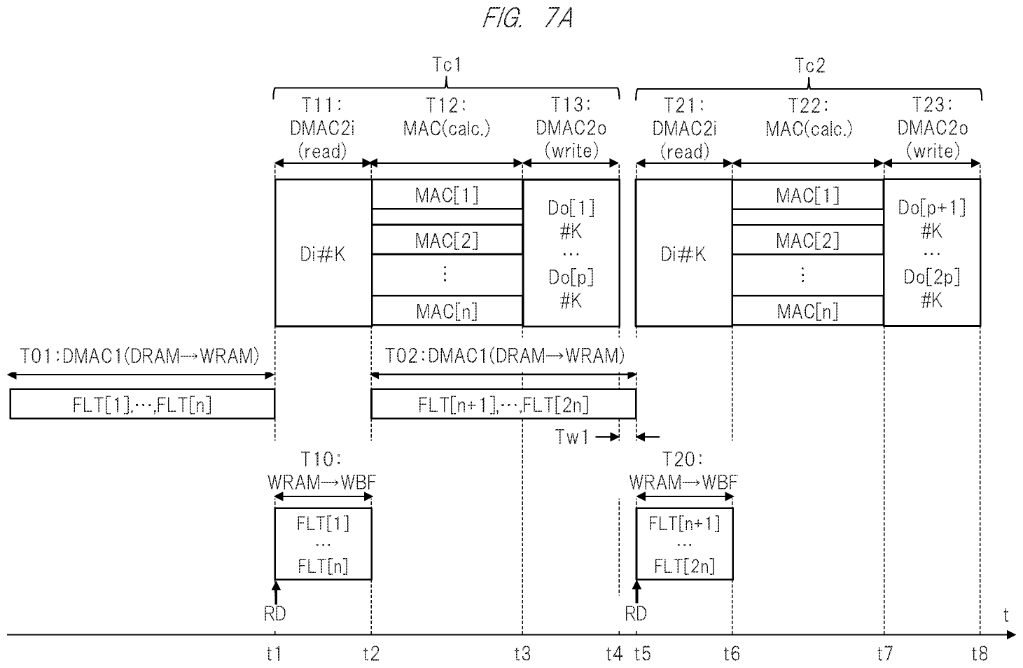

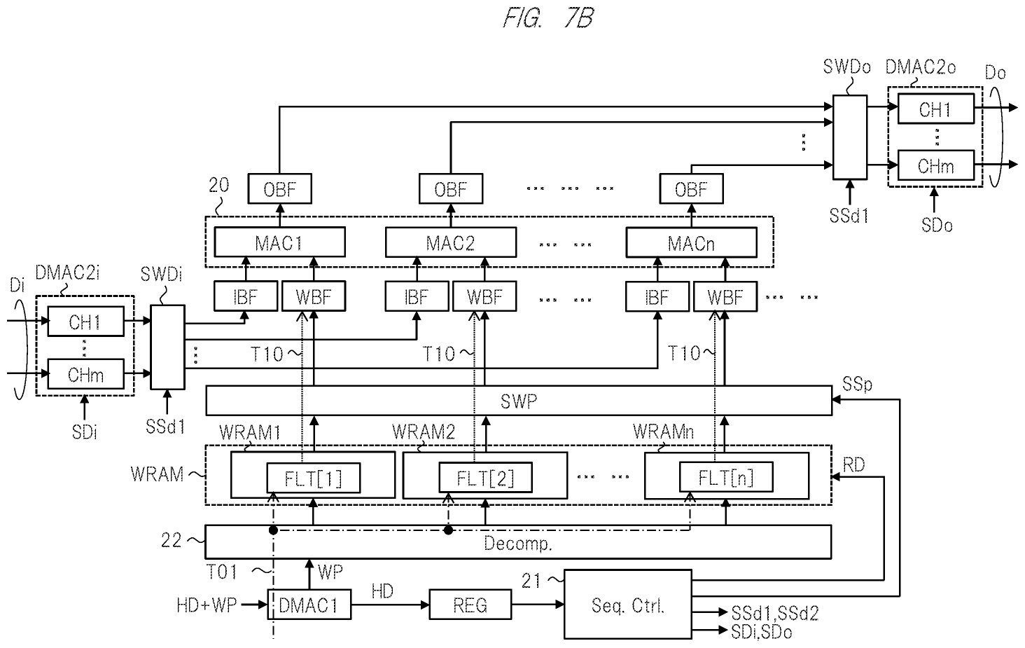

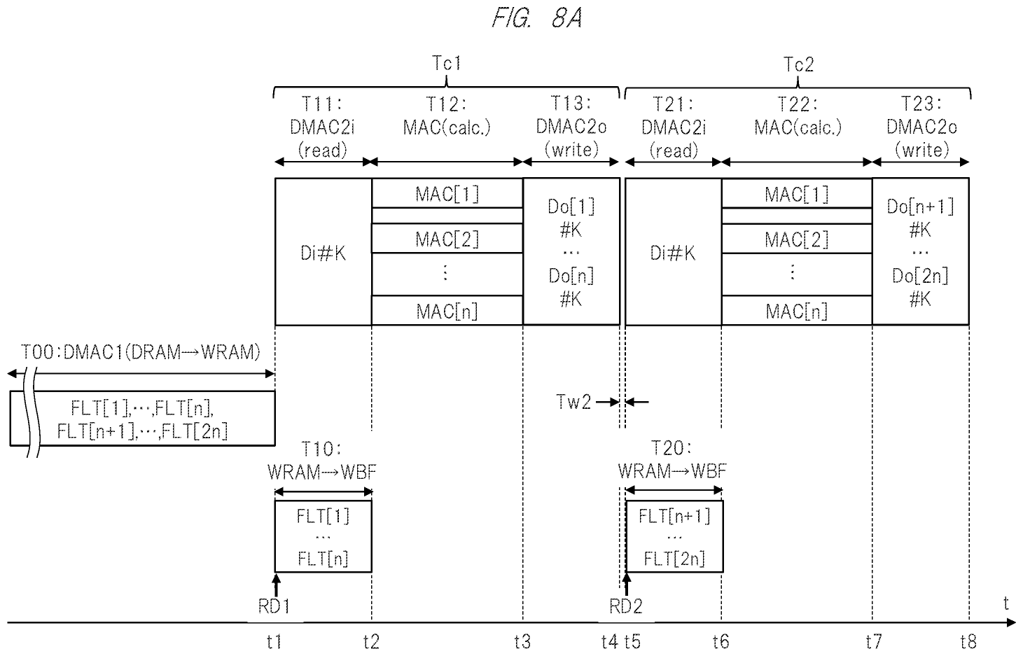

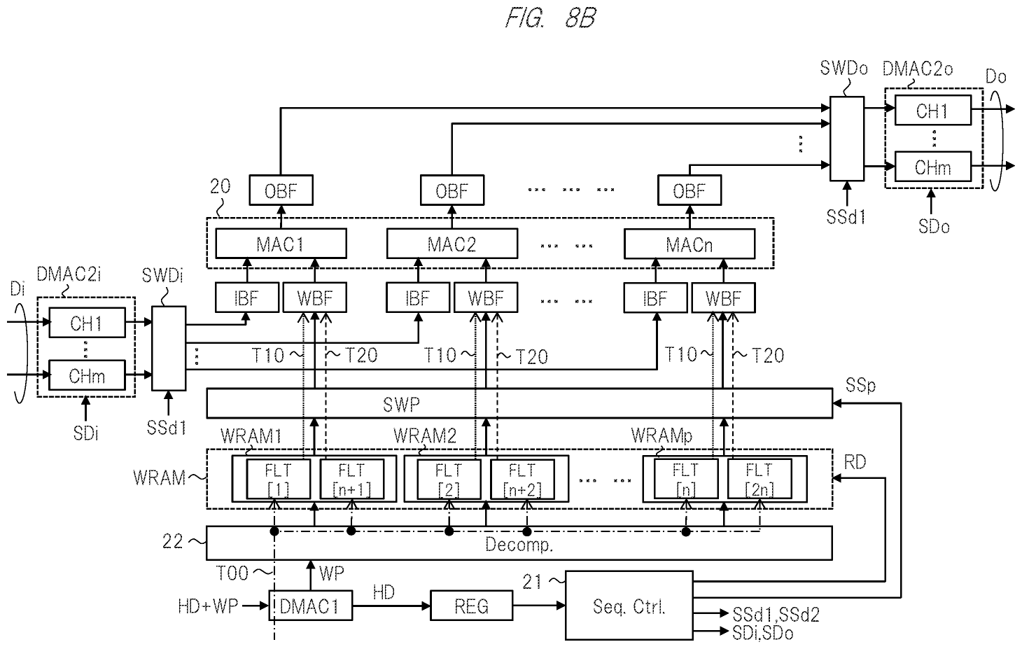

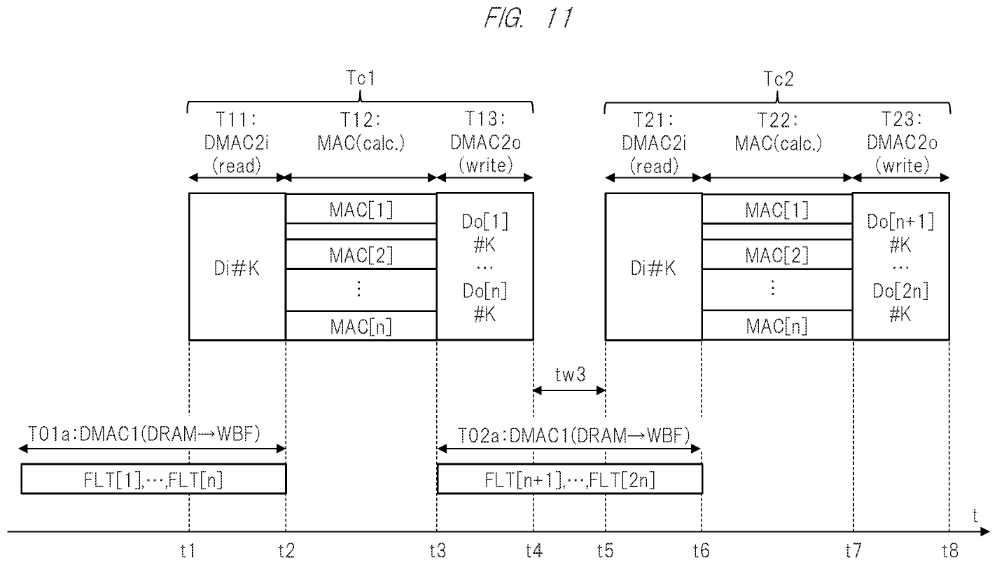

FIG. 7A is a timing chart showing a schematic operation example of the neural network engine in FIG. 4. FIG. 7B is a supplementary diagram for explaining an operation example of FIG. 7A. FIG. 8A is a timing chart showing an operation example different from that of FIG. 7A. FIG. 8B is a supplementary diagram for explaining an operation example of FIG. 8A. FIG. 11 is a timing chart showing a schematic operation example of a neural network engine as a comparative example.

First, the neural network engine as the comparative example has a configuration in which the memory WRAM for weight parameter is not provided in FIGS. 1 and 4. In this case, the operation shown in FIG. 11 is performed. In FIG. 11, after the operation the control cycle Tc1 as described in FIG. 3A, an operation in a control cycle Tc2 as described in FIG. 3B is performed. The control cycle Tc1 is composed of a period T11 from a time point t1 to a time point t2, a period T12 from the time point t2 to a time point t3, and a period T13 from the time point t3 to a time point t4.

In period T11, the DMA controller DMAC2i for data input transfers the input pixel data Di #K from the memory MEM2 to the data input buffer IBF via the switch circuit SWDi for data input. In the period T12, the n MAC circuits MAC1 to MACn perform the multiply-accumulate operations to the input pixel data Di #K and the weight parameters W contained in the filters FLT[1] to FLT[n] of the n output channels. In the period T13, the DMA controller DMAC2o for data output transfers the output pixel data Do[1]#K to Do[n]#K of the n output channels, which are stored in the data output buffer OBF, to the memory MEM2 via the switch circuit SWDo for data output.

Here, in order to perform the multiply-accumulate operations in the n MAC circuits MAC1 to MACn in the period T12, the weight parameter W must be stored in the weight parameter buffer WBF at time point t2. Therefore, in a period T01a parallel to the period T11, the DMA controller DMAC1 for parameter transfers the weight parameters W contained in the filters FLT[1] to FLT[n] of the n output channels, from the memory MEM1 to the weight parameter buffer WBF via the decompressor 22 and the switch circuit SWP for parameter. However, when the amount of data of the weight parameter W to be transferred is large, the period T01a becomes longer than the period T11. Therefore, a start time point of the period T01a is earlier than a time point of time point t1.

The control cycle Tc2 following the control cycle Tc1 is composed of a period T21 from a time point t5 to a time point t6, a period T22 from the time point t6 to a time point t7, and a period T23 from the time point t7 to a time point t8. During the periods T21, T22, and T23, the same operations as those during the periods T11, T12, and T13 in the control cycle Tc1 are performed, respectively. However, in the period T22, the multiply-accumulate operations are performed by using the filters of the n output channels as different from those in the period T12, that is, filters FLT[n+1] to FLT[2n].

In order to perform the multiply-accumulate operations in the n MAC circuits MAC1 to MACn in the period T22, the weight parameter W must be stored in the weight parameter buffer WBF at time point t6. Therefore, in a period T02a parallel to the period T21, the DMA controller DMAC1 for parameter transfers the weight parameters W contained in the filters FLT[n+1] to FLT[2n] of the n output channels, to the weight parameter buffer WBF as similar to the case of the period T01a.

However, the period T02a starts after, for example, time point t3 in order to prevent the weight parameter W stored in the weight parameter buffer WBF from changing in the middle of the period T12. As a result, as shown in FIG. 11, a long waiting time Tw3 may be required between the control cycles Tc1 and Tc2, that is, between the time points t4 and t5. The larger the amount of data of the weight parameter W to be transferred is, the longer the waiting time Tw3 probably is.

On the other hand, in the neural network engine equipped with the memory WRAM for weight parameter, for example, an operation as shown in FIG. 7A is performed. In the operation example of FIG. 7A, period T01a in FIG. 11 is replaced with period T01 and period T10, and period T02a is replaced with period T02 and period T20, respectively.

In the period T01, as similar to the case of the period T01a, the DMA controller DMAC1 for parameter transfers the weight parameters W contained in the filters FLT[1] to FLT[n] of the n output channels stored in the memory MEM1 via the decompressor 22. However, as different from the case of the period T01a, the transfer destination is not the weight parameter buffer WBF but the memory WRAM for weight parameter. In the example of FIG. 7A, the transfer of the weight parameter W to the memory WRAM for weight parameter is completed at time point t1.

At time point t1 at which the transfer of the weight parameter W is completed, the sequence controller 21 outputs a read signal RD to the memory WRAM for weight parameter. Accordingly, in the period T10 from time point t1 to time point t2, the weight parameters W contained in the filters FLT[1] to FLT[n] of the n output channels stored in the memory WRAM for weight parameter are written down to the weight parameter buffer WBF via the switch circuit SWP for parameter. The length of the period T10 is mainly determined by the read speed of the memory WRAM for weight parameter such as SRAM, and therefore, is sufficiently short.

Operations in periods T02 and T20 are also similar to operations in periods T01 and T10. However, the transfer targets in periods T02 and T20 are the filters FLT[n+1] to FLT[2n] of the n output channel as different from those in periods T01 and T10.

As described above, in the operation example shown in FIG. 7A, it is assumed that the memory MEM1 stores the compressed weight parameters WP of the plurality of channels used in the processing of the convolutional layers. Then, the DMA controller DMAC1 for parameter transfers the compressed weight parameters WP of some of the plurality of channels from the memory MEM1 to the memory WRAM for weight parameter via the decompressor 22. Further, in the DMA controller DMAC1 for parameter, the channels to be transferred to the memory WRAM for weight parameter are appropriately switched.

Here, as shown in FIG. 7A, the transfer of the weight parameter W from the memory MEM1 to the memory WRAM for weight parameter in period T02 can start at time point t2 as different from the case of period T02a shown in FIG. 11. That is, time point t2 is time point at which latching of the written down weight parameter W in the weight parameter buffer WBF is started and the memory WRAM for weight parameter is released due to the completion of the operation in the period T10. As a result, the waiting time Tw1 between the control cycles Tc1 and Tc2, that is, between the time points t4 and t5, can be shorter than the waiting time Tw3 in FIG. 11.

FIG. 7B shows a schematic operation example in periods T01 and T10 shown in FIG. 7A. In FIG. 7B, in period T01, weight parameters W of n filters FLT[1] to FLT[n] are transferred from a memory MEM1 (not shown) to n memories WRAM1 to WRAMn for weight parameter, respectively. That is, any one of the n memories WRAM1 to WRAMn for weight parameter and any other of the same store weight parameters W included in different channels. In the period T10, the weight parameters W of the n filters FLT[1] to FLT[n] stored in the n memories WRAM1 to WRAMn for weight parameter are written down to the n data input buffers IBF, respectively.

A single filter FLT may have a large filter size such as “X×Y×Chi=3×3×1024=9216”. In this case, when one weight parameter W is assumed to be of 8 bits (1 byte), each of the n memories WRAM1 to WRAMn for weight parameter may need to have a memory capacity of, for example, only about 10 kilo bytes.

In the operation example of FIG. 8A, periods T01 and T02 in FIG. 7A are replaced with period TOO which is a period before time point t1. In the period TOO, the DMA controller DMAC1 for parameter transfers the weight parameters W contained in the filters FLT[1] to FLT[2n] of the “2×n” output channels stored in the memory MEM1, to the memory WRAM for weight parameter via the decompressor 22. In the example of FIG. 8A, transfer of the weight parameter W to the memory WRAM for weight parameter is completed at time point t1.

At time point ti at which the transfer of the weight parameter W is completed, the sequence controller 21 outputs a read signal RD1 including the read address range to the memory WRAM for weight parameter. Accordingly, in the period T10 from time point t1 to time point t2, the weight parameters W contained in the filters FLT[1] to FLT[n] of the n output channels stored in the memory WRAM for weight parameter are written down to the weight parameter buffer WBF via the switch circuit SWP for parameter.

Similarly, at time point t5, the sequence controller 21 outputs a read signal RD2 including the read address range to the memory WRAM for weight parameter. Accordingly, in the period T20 from time point t5 to time point t6, the weight parameters W contained in the filters FLT[n+1] to FLT[2n] of another n output channels stored in the memory WRAM for weight parameter are written down to the weight parameter buffer WBF via the switch circuit SWP for parameter.

In the operation example shown in FIG. 8A, in addition to the weight parameter W to be transferred in period T01 in FIG. 7A, the weight parameter W to be transferred in period T02 is also previously transferred to the memory WRAM for weight parameter in period T00. As a result, the waiting time Tw2 between the control cycles Tc1 and Tc2, that is, between the time points t4 and t5, can be made further shorter than the waiting time Tw1 in FIG. 7A. However, since the length of the period T00 can be longer than the period T01 or the like, it is desirable to construct the entire sequence so as to mask this period by other setting processing or the like.

FIG. 8B shows a schematic operation example in periods T00, T10, and T20 shown in FIG. 8A. In FIG. 8B, in period T00, the weight parameters W of the two filters FLT are transferred from the memory MEM1 (not shown) to each of the n memories WRAM1 to WRAMn for weight parameter. For example, the weight parameters W of two filters FLT[1] and FLT[n+1] are transferred to the memory WRAM1 for weight parameter, and the weight parameters W of two filters FLT[n], FLT[2n] are similarly transferred to the memory WRAMn for weight parameter.

In period T10, the weight parameters W of the n filters FLT[1] to FLT[n] stored in the n memories WRAM1 to WRAMn for weight parameter are written down to the n data input buffers IBF, respectively. On the other hand, in period T20, the weight parameters W of another n filters FLT[n+1] to FLT[2n] stored in the n memories WRAM1 to WRAMn for weight parameter are written down to the n data input buffers IBF, respectively.

FIGS. 7A and 8A show the example of the operation in the above-described procedure A of performing the parallel processing in the output channel CHo direction first. However, the above-described procedure C of performing the parallel processing in the output channel CHo direction and the shift direction of the pixel space may be performed. As a specific example, the operation in the procedure A as shown in FIG. 7B is performed for one convolutional layer where a large size filter FLT is used. On the other hand, it is assumed that, for example, a filter FLT having a half size of that of the case of FIG. 7B is used for another convolutional layer.

In this case, for example, the size of filter FLT[1] in FIG. 8B is a half size of the filter FLT[1] in FIG. 7B. In this case, the number of multipliers MUL included in MAC circuit MAC1 in FIG. 8B may also be a half of that in FIG. 7B. Therefore, the MAC unit 20 is set so that the MAC circuit MAC1 in FIG. 8B is divided into two MAC circuits (assumed to be MAC1-1 and MAC1-2).

Then, the MAC circuit MAC1-1 performs a multiply-accumulate operation to the pixel data Di of the pixel space 26-1 shown in FIG. 3A and the weight parameter W of the filter FLT[1]. On the other hand, the MAC circuit MAC1-2 performs a multiply-accumulate operation to the pixel data Di of another pixel space 26-2 shown in FIG. 3A and the weight parameter W of the filter FLT[1]. At this time, the switch circuit SWP for parameter transfers the weight parameter W of the filter FLT[1] read out from the memory WRAM1 for weight parameter, to the two MAC circuits MAC1-1 and MAC1-2.

### <Main Effects of First Embodiment>

As described above, since the method of the first embodiment uses the memory WRAM for weight parameter that stores the weight parameter W restored by the decompressor 22, the time taken for replacing the weight parameter W to be stored in the weight parameter buffer WBF can be shortened. Particularly, such an effect can be obtained since the memory WRAM for weight parameter is arranged between the decompressor 22 and the weight parameter buffer WBF. As a result, the time for the neural network processing can be shortened.

Further, such an effect can be obtained along with the suppression of increase in the area overhead associated with the arrangement of the memory WRAM for weight parameter. Specifically, as another comparative example, it is conceivable to provide a cache memory similar to that in the case of the pixel data, that is, equivalent to the memory MEM2. In this case, for example, the filters FLT of all output channels CHo stored in the memory MEM1 and used in the certain convolutional layer, more specifically the compressed weight parameters WP constituting the filters FLT are previously copied into the cache memory.

As a specific example, when the number of output channels Cho is 1024, 1024 filters FLT are previously copied into the cache memory. This may increase the memory capacity required for the cache memory. On the other hand, in the method of the first embodiment, the memory WRAM for weight parameter is sufficient to have only a memory capacity as much as allowing the memory to store n filter FLTs where n is less than 1024, such as several ten to several hundred filters by storing some channels while switching the channels as shown in FIG. 7A and the like.

### Second Embodiment

<Details of Neural Network Engine>

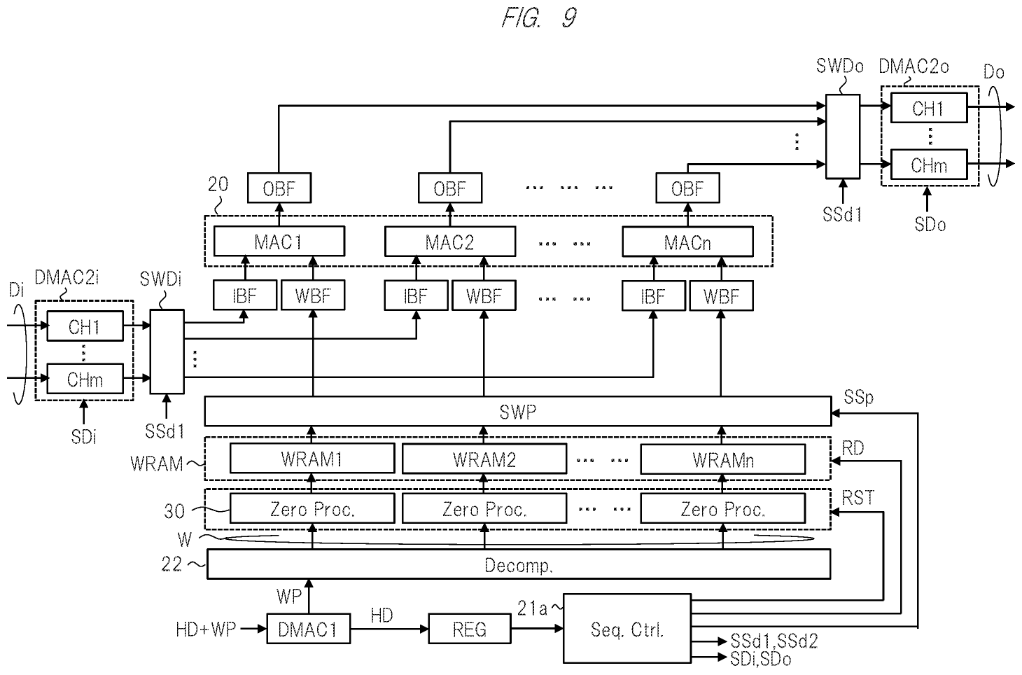

FIG. 9 is a diagram showing a detailed configuration example of a principal part of a neural network engine in FIG. 1 in a semiconductor device according to a second embodiment. The configuration example shown in FIG. 9 differs from the configuration example shown in FIG. 4 in the following two points. The first difference is that a zero processing circuit 30 is provided between the decompressor 22 and the memory WRAM for weight parameter. The second difference is that a sequence controller 21a outputs a reset signal RST to the zero processing circuit 30.

The sequence controller 21a resets all stored information stored in the memory WRAM for weight parameter to zero before start of the transfer of the weight parameter W to the memory WRAM for weight parameter. In this example, the sequence controller 21a outputs the reset signal RST to the zero processing circuit 30. The zero processing circuit 30 writes down all zeros into the memory WRAM for weight parameter in response to the reset signal RST. As an alternative method, the memory WRAM for weight parameter may be provided with a reset function of outputting the reset signal RST to the memory WRAM for weight parameter.

After that, when the weight parameters W are transferred to the memory WRAM for weight parameter, the zero processing circuit 30 detects non-zero weight parameters W from among the weight parameters W in the middle of the transfer to the memory WRAM for weight parameter. Then, the zero processing circuit 30 transfers only the detected non-zero weight parameters W to the memory WRAM for weight parameter.

Specifically, when one weight parameter W is of, for example, 8 bits, the zero processing circuit 30 may have a circuit that performs switching between passage and blocking of the 8 bits based on the 8-bit OR operation result, that is, the zero determination result. Alternatively, the zero processing circuit 30 may perform the zero determination with reference to the map data MPD input to the decompressor 22 as shown in FIG. 5.

<Main Effects of Second Embodiment>

As described above, by using the method of the second embodiment, in addition to the various effects described in the first embodiment, it is possible to reduce the amount of data used when the weight parameter W is written down into the memory WRAM for weight parameter. As a result, it is possible to shorten the time required for the writing and reduce the power consumption associated with the writing. That is, in actual CNN processing, the filter FLT may contain many weight parameters W that are zero. For this reason, the provision of the zero processing circuit 30 is beneficial.

### Third Embodiment

<Details of Neural Network Engine>

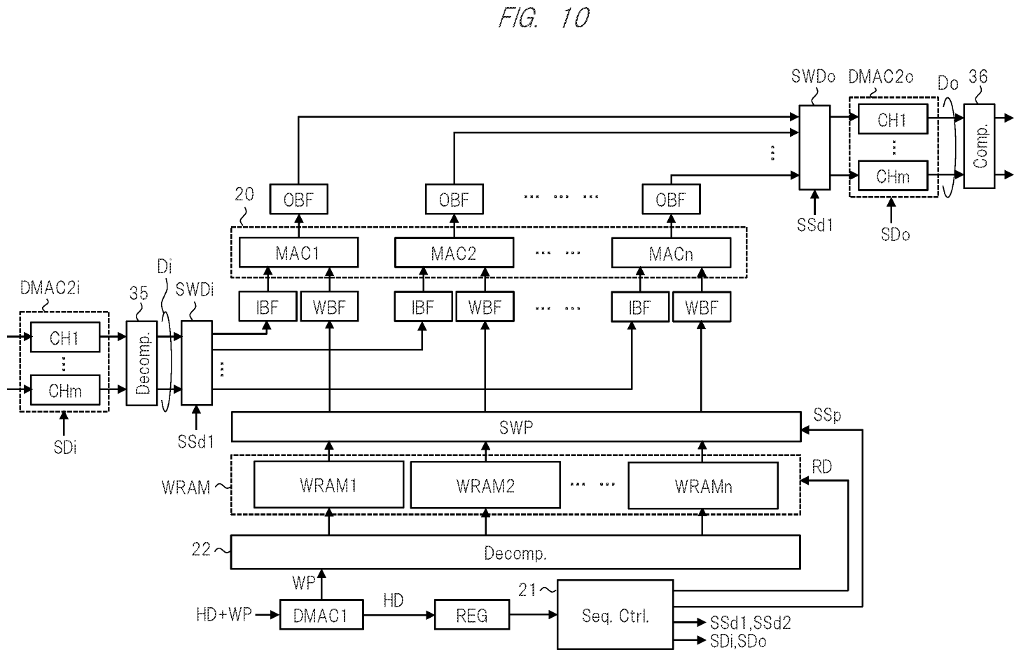

FIG. 10 is a diagram showing a detailed configuration example of a principal part of a neural network engine in FIG. 1 in a semiconductor device according to a third embodiment. The configuration example shown in FIG. 10 differs from the configuration example shown in FIG. 4 in the following two points. The first difference is that a decompressor 35 is provided between the DMA controller DMAC2i for data input and the switch circuit SWDi for data input. The second difference is that a compressor 36 is provided on the output path of the DMA controller DMAC2o for data output.

The compressor 36 compresses the output pixel data Do output from the DMA controller DMAC2o for data output, and outputs it to the memory MEM2. The compression scheme may be, for example, a lossless scheme for the decompression scheme as described in FIG. 5. On the other hand, the decompressor 35 restores the compressed input pixel data output from the DMA controller DMAC2i for data input, and outputs it to the data input buffer IBF via the switch circuit SWDi for data input. The decompressor 35 may be configured similarly to the decompressor 22 for the weight parameter W.

<Main Effects of Third Embodiment>

As described above, when the method of the third embodiment is used, in addition to the various effects described in the first embodiment, the amount of data in the transfer of the pixel data Di and Do to and from the memory MEM2 can be reduced by the provision of the compressor 36 and the decompressor 35. As a result, it is possible to reduce the memory capacity required for the memory MEM2.

In the foregoing, the invention made by the inventors of the present application has been concretely described on the basis of the embodiments. However, it is needless to say that the present invention is not limited to the foregoing embodiments, and various modifications can be made within the scope of the present invention.

What is claimed is:

1. A semiconductor device performing neural network processing, comprising:
a first memory configured to store a compressed weight parameter;
a second memory configured to store a plurality of pixel data;
a plurality of multiply accumulators configured to perform a multiply-accumulate operation to the plurality of pixel data and a plurality of weight parameters;
a weight parameter buffer configured to output the plurality of weight parameters to the plurality of multiply accumulators;
a data input buffer configured to output the plurality of pixel data to the plurality of multiply accumulators;
a decompressor configured to restore the compressed weight parameter stored in the first memory to the plurality of weight parameters;
a third memory provided between the decompressor and the weight parameter buffer and configured to store the plurality of weight parameters restored by the decompressor;
a first DMA controller configured to read out the compressed weight parameter from the first memory and to transfer the plurality of weight parameters to the third memory via the decompressor;
a second DMA controller configured to transfer the plurality of pixel data from the second memory to the data input buffer; and
a sequence controller configured to write down the plurality of weight parameters stored in the third memory to the weight parameter buffer at write timing.

2. The semiconductor device according to claim 1,
wherein the first memory is a DRAM, and
the third memory is an SRAM.

3. The semiconductor device according to claim 1,
wherein the write timing is timing synchronized with timing at which transfer of the plurality of pixel data to the data input buffer is completed.

4. The semiconductor device according to claim 2,
wherein the first memory stores the compressed weight parameters of a plurality of channels used in convolution layer processing of a neural network, and
the first DMA controller transfers the compressed weight parameters of some of the plurality of channels from the first memory to the third memory via the decompressor.

5. The semiconductor device according to claim 4,
wherein a plurality of the third memories are provided, and
any one and any other of the plurality of third memories store the plurality of weight parameters contained in mutually different channels.

6. The semiconductor device according to claim 1, further comprising
a zero processing circuit provided between the decompressor and the third memory,
wherein the sequence controller resets all stored information in the third memory to zero before the transfer of the plurality of weight parameters by the first DMA controller is started, and
the zero processing circuit detects a non-zero weight parameter among the plurality of weight parameters in the middle of the transfer to the third memory, and transfers only the detected non-zero weight parameter to the third memory.

7. A semiconductor device composed of one semiconductor chip, comprising:
a neural network engine configured to perform neural network processing;
a first memory configured to store a compressed weight parameter;
a second memory configured to store a plurality of pixel data;
a processor; and
a bus configured to interconnect the neural network engine, the first memory, the second memory and the processor,
wherein the neural network engine includes:
a plurality of multiply accumulators configured to perform a multiply-accumulate operation to the plurality of pixel data and a plurality of weight parameters;
a weight parameter buffer configured to output the plurality of weight parameters to the plurality of multiply accumulators;
a data input buffer configured to output the plurality of pixel data to the plurality of multiply accumulators;
a decompressor configured to restore the compressed weight parameter stored in the first memory to the plurality of weight parameters;
a third memory provided between the decompressor and the weight parameter buffer and configured to store the plurality of weight parameters restored by the decompressor;
a first DMA controller configured to read out the compressed weight parameter from the first memory and to transfer the plurality of weight parameters to the third memory via the decompressor;
a second DMA controller configured to transfer the plurality of pixel data from the second memory to the data input buffer; and
a sequence controller configured to write down the plurality of weight parameters stored in the third memory to the weight parameter buffer at write timing.

8. The semiconductor device according to claim 7,
wherein the first memory is a DRAM, and
the third memory is an SRAM.

9. The semiconductor device according to claim 7,
wherein the write timing is timing synchronized with timing at which transfer of the plurality of pixel data to the data input buffer is completed.

10. The semiconductor device according to claim 8,
wherein the first memory stores the compressed weight parameters of a plurality of channels used in convolution layer processing of a neural network, and
the first DMA controller transfers the compressed weight parameters of some of the plurality of channels from the first memory to the third memory via the decompressor.

11. The semiconductor device according to claim 10,
wherein a plurality of the third memories are provided, and
any one and any other of the plurality of third memories store the plurality of weight parameters contained in mutually different channels.

12. The semiconductor device according to claim 7,
wherein the neural network engine further includes a zero processing circuit provided between the decompressor and the third memory,
the sequence controller resets all stored information in the third memory to zero before the transfer of the plurality of weight parameters by the first DMA controller is started, and
the zero processing circuit detects a non-zero weight parameter among the plurality of weight parameters in the middle of the transfer to the third memory, and transfers only the detected non-zero weight parameter to the third memory.
